(19) United States
(12) Patent Application Publication
(10) Pub. No.: US 2025/0176508 A1
(43) Pub. Date: Jun. 5, 2025

(54) A LIGHTING SYSTEM FOR ILLUMINATING AN AQUACULTURE RESERVOIR

(71) Applicant: SIGNIFY HOLDING B.V., EINDHOVEN (NL)

(72) Inventor: PETER DEIXLER, ARLINGTON, MA (US)

(21) Appl. No.: 18/845,028

(22) PCT Filed: Mar. 7, 2023
(86) PCT No.: PCT/EP2023/055746

§ 371 Date: Sep. 9, 2024

Related U.S. Application Data
(60) Provisional application No. 63/318,482, filed on Mar. 10, 2022.

(30) Foreign Application Priority Data
Mar. 24, 2022 (EP) 22164067.5

(51) Int. Cl. A01K 63/06; A01K 61/59; H05B 47/175

(52) U.S. Cl. CPC A01K 63/06; A01K 61/59; H05B 47/196

(57) ABSTRACT

The invention provides a lighting system (10) for illuminating an aquaculture reservoir (4), wherein the aquaculture reservoir comprises an aquatic species 3, first microbes (1), and second microbes (2) other than the first microbes, wherein the lighting system comprises: a light source (5) for illuminating the aquaculture reservoir with light source light; a lighting controller (7) configured to: (i) obtain a first microbiome signal (71) indicative of the first microbes 1 being present in the aquaculture reservoir and a second microbiome signal (72) indicative of the second microbes (2) being present in the aquaculture reservoir; (ii) select a lighting characteristic based on the first microbiome signal and the second microbiome signal, wherein the selected lighting characteristic is configured to promote the persistence of the first microbes relative to the second microbes in the aquaculture reservoir; (iii) control the light source to illuminate the aquaculture reservoir with light source light comprising said selected lighting characteristic. The invention provides a lighting system (10) for illuminating an aquaculture reservoir (4), wherein the aquaculture reservoir comprises an aquatic species (3), first microbes (1), and second microbes (2) other than the first microbes, wherein the lighting system comprises: a light source (5) for illuminating the aquaculture reservoir with light source light; a lighting controller (7) configured to: (i) obtain a first microbiome signal 71 indicative of the first microbes (1) being present in the aquaculture reservoir and a second microbiome signal (72) indicative of the second microbes (2) being present in the aquaculture reservoir.

### FIELD OF THE INVENTION

The invention relates to a lighting system for illuminating an aquaculture reservoir. The lighting system comprises a light source and a lighting controller. The invention further relates to a method of illuminating an aquaculture reservoir.

### BACKGROUND OF THE INVENTION

Aquaculture contributes increasingly to the worldwide production of animal protein with aquatic-based protein. Especially, the global shrimp sector experiences a rapid economic growth. For example, Penaeid shrimp aquaculture (including tiger prawn, white leg shrimp, Atlantic white shrimp, and Indian prawn) is an important source of economic gain for many Asian and Latin American countries.

Consequently, as shrimp aquaculture is becoming more intensive, the focus on animal health during the production phase becomes ever more important. However, intensive shrimp farming has been negatively affected by various diseases, such as for example White

Spot Syndrome Virus (WSSV), Yellow Head Virus (YHV), White Feces Syndrome (WFS) and Early Mortality Syndrome (EMS). These pathogens pose a major limitation to the growth of the shrimp farming sector. In particular tiger shrimp (Penaeus monodon) are prone to diseases.

Hence, it is important to mitigate the onset of disease, and subsequent mortality, in shrimp aquaculture. To cope with such pathogens undermining shrimp aquaculture, antibiotic use has been the most important and effective strategy to control and prevent bacterial infections for the past two decades.

However, the use of antibiotics has negative consequences for human and environmental health, inducing resistance to antibiotics in shrimp farming and promoting transference of antibiotic resistance genes. Moreover, antibiotics may have a detrimental impact on the gut microbiome of the host species, such as the shrimp.

Gut microbiome manipulation, by means of microbiota supplementation to the rearing water, is a known possible alternative to the use of antibiotics for managing disease in shrimp farming. It is for example known that the gut microbiome that colonizes the shrimp's gut interacts with the shrimp and contributes to a number of key host processes, such as for example digestion, improvement of intestinal balance and immune response. Microbiota supplementation, with e.g. probiotics, has clearly demonstrated positive effects on both growth and survival of shrimp—and mutatis mutandis of several other commercial aquaculture species. For example, Bacillus is well recognized as a probiotic for crustaceans.

Even though microbiome manipulation with probiotics provides an advantageous alternative to the use of antibiotics in aquaculture, such as for shrimp farming in particular, the use of probiotic mixtures often copes with a limited proliferation potential in the rearing water for probiotic bacterial species (of the mixture) that are e.g. not indigenous to the marine environment to which these species are supplied. This may reduce the effectiveness of the supplemented probiotic mixture, and the efficient treatment of the aquatic species therewith, such as the shrimp.

Hence, a clear need exists to mitigate disease in aquaculture, reduce the use of antibiotics, and improve the effectiveness and/or efficiency of microbiota supplementation with probiotic mixtures as supplied to the rearing water of aquatic species. Document KR102272902B1 discloses a shrimp culture system.

### SUMMARY OF THE INVENTION

It is an object of the invention to provide an improved lighting system for illuminating an aquaculture reservoir, which at least alleviates the problems and disadvantages mentioned above. Thereto, the invention provides a lighting system for illuminating an aquaculture reservoir, wherein the aquaculture reservoir comprises an aquatic species, first microbes, and second microbes other than the first microbes, wherein the lighting system comprises: a light source for illuminating the aquaculture reservoir with light source light; a lighting controller configured to: (i) obtain a first microbiome signal indicative of the first microbes being present in the aquaculture reservoir and a second microbiome signal indicative of the second microbes being present in the aquaculture reservoir; (ii) select a lighting characteristic based on the first microbiome signal and the second microbiome signal, wherein the selected lighting characteristic is configured to promote the persistence of the first microbes relative to the second microbes in the aquaculture reservoir; (iii) control the light source to illuminate the aquaculture reservoir with light source light comprising said selected lighting characteristic.

Hence, the present invention provides a lighting system for illuminating an aquaculture reservoir with light source light. The aquaculture reservoir comprises an aquatic species, first microbes, and second microbes other than the first microbes. Said first microbes may be beneficial microbes, such as a probiotic bacterial species. Said second microbes may be detrimental microbes, such as bacterial species pathogenic to the aquatic species.

However, the (beneficial) first microbes may cope with a limited proliferation potential in the marine environment of the aquaculture reservoir, and thereby be limited to effectively treat the aquatic species. Therefore, the lighting controller according to the invention controls the light source to illuminate the aquaculture reservoir with light source light. The light source light comprises a lighting characteristic. The lighting characteristic is selected based on the obtained first microbiome signal and the obtained second microbiome signal, that are respectively indicative of the first microbes and second microbes being present in the aquaculture reservoir. More specifically, in embodiments, the lighting characteristic may for example be selected based on an obtained first action spectrum (related to the first microbes based on the first microbiome signal) and an obtained second action spectrum (related to the second microbes on the second microbiome signal). As a result, the lighting system according to the present invention illuminates the aquaculture reservoir with light source light selected to promote, and suitable for promoting, the persistence of the first microbes relative to the second microbes in the aquaculture reservoir.

In particular, the light source light (comprising the selected lighting characteristic) may be beneficial for the growth and proliferation of the first microbes, and/or may be detrimental to the growth of the second microbes. The first microbes are thereby given a competitive advantage over the second microbes and/or the otherwise limiting marine environment of the aquaculture reservoir, thus allowing the first microbes to settle and persist in the aquaculture reservoir, and further improving their proliferation in the aquaculture reservoir.

Consequently, the aquatic species (that are also present in the same aquaculture reservoir) can more effectively come in contact with the first microbes, and thereby be supplemented with the first microbes. All in all, the present invention promotes the beneficial effects of microbiota supplementation in aquaculture, by purposively selecting a lighting characteristic based on the first and second microbes that are being present in the aquaculture reservoir, which lighting characteristic promotes the persistence of the first microbes relative to the second microbes in the aquaculture reservoir. Hence, the present invention improves the otherwise limited proliferation of the first microbes in the aquaculture reservoir.

In aspects, the lighting system according to the present invention may selectively promote first microbes versus second microbes, wherein the first microbes may be known to be relatively robust against a selected wavelength of light, and wherein the second microbes may be more susceptible to said selected wavelength. Such a selected wavelength may for example be 222 nm UV light, or 405 nm light. The first microbe may for instance also be damaged or deactivated by the selected wavelength, but to a lesser degree than the second microbe, such as due to a lower absorption of radiation at the selected wavelength, or such as due to better or more active repair mechanisms. Hence, the selected wavelength may shift the competitive balance between the first microbes and second microbes in the aquaculture reservoir, thereby helping the first microbes to proliferate in the aquaculture reservoir via a competitive exclusion mechanism (excluding the second microbes that may otherwise limit the proliferation of the first microbes).

Thereby, the response of microbes to particular spectra of light (such as for example UV light) and their sensitivity across the light spectrum is commonly referred in literature as action spectrum (or: action spectra).

Said first microbes (or: first micro-organisms) may especially comprise beneficial microbes, including microbes with (direct) health benefits to the aquatic species in the aquaculture reservoir, such as probiotic bacteria; but said first microbes may also comprise microbes that may compete with pathogenic (or otherwise undesirable) microbes in the aquaculture reservoir, and may thereby (indirectly) provide health benefits to the aquatic species in the aquaculture reservoir. Said second microbes (or: second micro-organisms) may be such pathogenic (or otherwise undesirable) microbes. Said second microbes may also be microbes limiting the proliferation of the first microbes in the aquaculture reservoir, e.g. due to their competitive dominance thereover.

In the present application, throughout the application, the term used as ‘microbe’ does not only encompass bacteria, protozoa, fungi, algae, amoebas, molds, parasites, but also encompasses viruses. Alternatively, throughout the application, said term ‘microbe’ may be phrased as ‘micro-organisms and viruses’.

The aquaculture reservoir may comprise a water volume. The water volume may comprise a water surface, which may form the interface of the volume water with the ambient atmosphere. The aquaculture reservoir may define a marine environment, wherein the marine environment comprises an initial microbiome, or natural habitat.

Said first microbiome signal may be a first control signal. Said second microbiome signal may be a second control signal. Said first microbiome signal and/or said second microbiome signal may be communicated via a known wireless communication modality, or a known wired communication modality.

In aspects, alternatively phrased, the second microbiome signal according to the invention may be indicative of the second microbes being present in the aquaculture reservoir and/or being expected to be present in the aquaculture reservoir. For example, a pathogenic second microbe may be present in the aquaculture reservoir, wherein the second microbiome signal may be a proxy for said pathogenic second microbe being present in the aquaculture reservoir (i.e. e.g. the second microbes indirectly being confirmed to be present (i.e. expected to be present) in the aquaculture reservoir via said proxy).

In embodiments, the first microbes may be selected from the group comprising the genera Bacillus, for example. The first microbes may for example be Bacillus acidophilus, B. subtilis, B. licheniformis. The first microbes may also be selected from the group comprising: Lactobacillus, Saccharomyces cerevisiae, Streptococci, Roseobacter. Such first microbes may be common probiotics in aquaculture. The first microbes may also be selected from the group comprising: Aerobacter, Nitrobacter spp. Furthermore, the first microbes may also alternatively be selected from the group comprising: Acinetobacter, Cellulomonas, Rhodopseudomonas, Pseudomonas, Nitrosomonas. Such bacteria may decompose organic substances in the marine environment of the aquaculture reservoir that are otherwise toxic to the aquatic species (such as shrimp), so as to improve the health of the aquatic species.

In further aspects, the first microbes may especially comprise a plurality of different species, such as different genera. Hence, the first microbes may comprise a microbial community of two or more of bacterial species or genera.

As mentioned, the lighting controller according to the invention is configured to obtain a first microbiome signal indicative of the first microbes being present in the aquaculture reservoir, and to obtain a second microbiome signal indicative of the second microbes being present in the aquaculture reservoir. The lighting controller may thereby receive or retrieve said first microbiome signal and/or said second microbiome signal.

In an embodiment, the lighting system may comprise a user interface device; wherein the user input device may be configured to receive an user input and determine the first microbiome signal and/or the second microbiome signal based on said user input; wherein the user input is indicative of the first microbes and/or the second microbes being present in the aquaculture reservoir; wherein the lighting controller may be configured to receive said first microbiome signal and/or said second microbiome signal from said user interface device.

Hence, the lighting controller may receive the first microbiome signal and/or said second microbiome signal from the user interface device. The user interface device may determine the first microbiome signal and/or said second microbiome signal based on the user input. This enables a user to actively control the lighting controller.

The user interface device may comprise a user interface. The user interface may comprise at least one user interface element. Said user interface element may for example be indicative of first microbes and/or second microbes. Said user interface element may for example be at least one of: a button, a menu, a drop-down menu, a list, a slider, an image, a switch, a text entry box, a tick box, a query box, a voice entry means, etc.

More specifically: The user input may for example be a user selection of the first microbes and/or the second microbes. Such a user selection may for example be performed on the user interface device, or on the user interface of the user interface device in particular. Hence, a user may select or indicate—e.g. by selecting a user interface element, or e.g. operating a user interface element—that the first microbes and/or the second microbes are in the aquaculture reservoir. For example, the user itself may have provided the first microbes to the aquaculture reservoir, and consequently provide a related user input to the user interface device such that the first microbiome signal is conveyed to the lighting controller. Similarly, the user may have noticed the presence of pathogenic second microbes in the aquaculture reservoir (e.g. by assessing a condition of the aquatic species), and/or the user may have a preference to prevent a pathogenic second microbe to proliferate over the first microbe in the aquaculture reservoir. Consequently, the user may provide a related user input to the user interface device such that the first microbiome signal and/or the second microbiome signal is conveyed to the lighting controller.

In an embodiment, the lighting controller may comprise the user interface device. For example, the lighting controller may house the user interface device. For example, the user interface device may be part of the lighting controller. The user interface device may be a user interface; or the user interface device may comprise a user interface. The user interface device may for example be a touchscreen display, or a remote control.

In an embodiment, the lighting system may comprise a sensor device; wherein the sensor device is configured to receive a sensor input and determine the first microbiome signal and/or the second microbiome signal based on said sensor input; wherein the sensor input is indicative of the first microbes and/or the second microbes being present in the aquaculture reservoir; wherein the lighting controller is configured to receive said first microbiome signal and/or said second microbiome signal from said sensor device.

Hence, the lighting controller may receive the first microbiome signal and/or said second microbiome signal from the sensor device. The sensor device may determine the first microbiome signal and/or said second microbiome signal based on the sensor input. This enables (an at least partly) automatic operation of the lighting system based on the sensor input. The sensor input may for example be the detection signal indicative of the first microbes and/or the second microbes being present in the aquaculture reservoir.

In an embodiment, the light source may comprise the sensor device. The sensor device may thus be part of the light source. Yet in another embodiment, the lighting controller may comprise the sensor device. The sensor device may thus be part of the light source.

The sensor device may for example be a water quality sensor. The sensor device may for example be a biosensor. A biosensor may for example be defined as a measurement system for analyte detection, which measurement system combines a biological component with a physicochemical detector. Said sensor device may encompass bacterial detection techniques common in the art.

In an embodiment, the lighting system may comprise a sensor device and a user interface device, wherein the sensor device is configured to receive a sensor input and determine the second microbiome signal based on said sensor input, wherein the user interface device is configured to receive a user input indicative of the first microbiome signal based on said sensor input, wherein the lighting controller may receive or retrieve the first microbiome signal from the sensor device and the second microbiome signal from the user interface device.

It is known that the microbiome of the shrimp may affect the appearance of its digestive tract, i.e. the dark line visible on the back of a shrimp. It is also known that the presence of probiotic microbes and/or pathogenic microbes in the marine environment of an aquaculture tank affects the microbiome inside the body of a fish. For example, for Atlantic Salmon, it has been found that the gut microbiota profile of the Atlantic Salmon correlates with flesh pigmentation of the Atlantic Salmon. Flesh pigmentation may occur on the body or fillet of said fish.

Hence, said sensor device according to the invention may be an image sensor. The image sensor may for example be a camera. The image sensor may detect the appearance of an aquatic animal, such as shrimp or salmon. Said appearance may also be the average appearance of a plurality of aquatic animals. The detected appearance may be indicative of the presence of the first microbes and/or the second microbes in the aquaculture reservoir. For example, the appearance digestive tract of shrimp may be indicative of the presence of probiotic bacteria, whereas the appearance of the flesh pigmentation of Atlantic Salmon may be indicative of pathogenic second microbes being present in the aquaculture reservoir.

Hence, in an embodiment, the lighting system may comprise an image sensor; wherein the image sensor is configured to receive an image input and determine the first microbiome signal and/or the second microbiome signal based on said image input; wherein the image input may be indicative of the first microbes and/or the second microbes being present in the aquaculture reservoir; wherein the lighting controller is configured to receive said first microbiome signal and/or said second microbiome signal from said image sensor.

In aspects, the image sensor may comprise processing power to process the image input, and subsequently determine the first microbiome signal and/or the second microbiome signal locally at the image sensor. For example, the image sensor may comprise processing power suitable for image analysis, image recognition, and/or for machine learning, as known in the art.

In aspects, said first microbiome signal and/or the second microbiome signal may be the image input, (i.e. being indicative for the first microbes and/or the second microbes being present in the aquaculture reservoir), wherein said image input is conveyed to the lighting controller as the first microbiome signal and/or the second microbiome signal. The lighting controller may then be configured to process the first microbiome signal and/or the second microbiome signal, and determine or select the lighting characteristic based on the first microbiome signal and the second microbiome signal.

In an embodiment, the lighting system may comprise a microbiome dispenser device; wherein the microbiome dispenser device may be configured to provide, in operation, the first microbes to the aquaculture reservoir. Hence, the lighting system may comprise a microbiome dispenser device providing the first microbes to the aquaculture reservoir and subsequently providing the light source light comprising the lighting characteristic, so as to proliferate the first microbes in the aquaculture reservoir, as the selected lighting characteristic is configured to promote the persistence of the first microbes relative to the second microbes in the aquaculture reservoir. The microbiome dispenser device may similarly be a bioreactor supplying the aquaculture reservoir with water, said water for example comprising probiotics or a probiotic mixture.

In a related embodiment, the microbiome dispenser device is configured to convey, upon providing the first microbes to the aquaculture reservoir, said first microbiome signal to the lighting controller. Said first microbiome signal may for example be conveyed via a wireless communication modality, such as e.g. Wi-Fi, Bluetooth, RFID, NFC, RF, Infrared, VLC, Li-Fi, Lo-Ra, UWB, etc. Alternatively, said first microbiome signal may for example be conveyed via a wired connection, or wired communication modality.

In an aspect, the lighting controller may be configured to receive or retrieve a harvest signal, wherein the harvest signal is indicative of the aquatic species being harvested or removed from the aquatic reservoir at a pre-defined moment in time, wherein the lighting controller is configured to stop controlling the light source to illuminate the aquaculture reservoir with said light source light during a time period, wherein said time period starts before the pre-defined moment in time and stops at the pre-defined moment in time, wherein said time period comprises a duration of at least 8 hours. Said time period ma for example be at least 12 hours, or at least 24 hours.

In an embodiment, the aquatic species may be crustaceans. Alternatively, the aquatic species may be fish. In an embodiment, the crustaceans may be shrimp. In an embodiment, the crustaceans may be prawn. In an embodiment, the crustaceans may be at least one of: shrimp, prawn, lobster, crab, krill.

In an embodiment, the aquaculture reservoir is an aquatic species tank or a bioreactor. The aquaculture reservoir may alternatively be a pond, a basin, an aquarium, a hatchery.

In an embodiment, the aquaculture reservoir may comprise a water volume, wherein the light source is submerged in said water volume. Such an embodiment may be advantageous to improve the proliferation of the first microbes in the aquaculture reservoir, because the submerged light source can more effectively illuminate said first microbes and/or said second microbes, thereby affecting the conditions in the marine environment of the aquaculture reservoir. This may particularly be advantageous for aquaculture, where the rearing water (and marine environment) may be polluted, turbid, feculent and/or mirky due to the production of the aquatic species.

In an embodiment, the lighting controller may be configured to obtain a first action spectra related to the first microbes based on the first microbiome signal, and obtain a second action spectra related to the second microbes on the second microbiome signal, said first action spectra defining the sensitivity (or: light absorbance) of the first microbes relative to different wavelengths of light, and said second action spectra defining the sensitivity (or: light absorbance) of the second microbes relative to different wavelengths of light. Moreover, the lighting controller may be configured to select the lighting characteristic based on the first action spectra and the second action spectra.

Hence, the invention may in such embodiments provide: a lighting system for illuminating an aquaculture reservoir, wherein the aquaculture reservoir comprises an aquatic species, first microbes, and second microbes other than the first microbes, wherein the lighting system comprises: a light source for illuminating the aquaculture reservoir with light source light; a lighting controller configured to: (i) obtain a first microbiome signal indicative of the first microbes being present in the aquaculture reservoir and a second microbiome signal indicative of the second microbes being present in the aquaculture reservoir; (ii) obtain a first action spectrum related to the first microbes based on the first microbiome signal, and obtain a second action spectrum related to the second microbes on the second microbiome signal; (iii) select a lighting characteristic based on the first action spectrum and the second action spectrum, wherein the selected lighting characteristic is configured to promote the persistence of the first microbes relative to the second microbes in the aquaculture reservoir; (iv) control the light source to illuminate the aquaculture reservoir with light source light comprising said selected lighting characteristic. The phrase action spectra may also be action spectrum. A higher sensitivity or light absorbance may indicate a higher rate of light-based deactivation of the respective microbes. As mentioned, the selected lighting characteristic is configured to promote the persistence of the first microbes relative to the second microbes in the aquaculture reservoir. In related embodiments, the lighting controller may be configured to compare the first action spectrum and the second action spectrum. Namely, in other words, the lighting controller may be configured to determine and/or select the lighting characteristic by comparing the first action spectrum and the second action spectrum. Thereby, as partly mentioned, the lighting characteristic may be one of: a light spectrum and/or light intensity, and/or a spectral power distribution. Said lighting characteristic is suitable for promoting the persistence of the first microbes relative to the second microbes in the aquaculture reservoir.

In aspects, the lighting system according to the invention may further comprise a memory device, wherein said memory device comprises the first action spectrum and the second action spectrum. The memory device may be phrased as a database. The memory device may further comprise a further action spectrum related to further microbes. In examples, the lighting controller may comprise the memory device. Hence, the memory device may be local to the lighting controller. In other examples, the memory device may at least partly be remote (or: separate) from the lighting controller. For example, the memory device may be a remote service or cloud.

As partly mentioned, in embodiments, the first microbes may comprise Bacillus. In embodiments, the first microbes may be one or more of the group of: Bacillus, B. acidophilus, B. subtilis, B. cereus, B. pumilus, B. licheniformis, B. thuringiensis, B. weihenstephanensis, Lactobacillus, Aerobacter, Nitrobacter spp., Saccharomyces cerevisiae, Acinetobacter, Cellulomonas, Streptococci, Streptococcus agalactiae, Acinetobacter baumannii, Methylomonas methanica, Pseudomonas Stutzeri, Pseudoxanthomonas suwonensis, Geobacillus thermoleovorans, Macrococcus caseolyticus, Sphingobacterium ingobacterium sp., Weeksella virosa, Pedobacter saltans, Oceanithermus profundus, Mycoplasma synoviae, Colwellia, psychrerythraea, Ketogulonicigenium vulgare, Salmonella enterica, Xanthomonas albilineans, Nocardioides sp., Borrelia relia sp. Roseobacter.

Such first microbes may be probiotic and beneficial for aquatic species, such as for example crustaceans. To illustrate: The probiotic Actinobacteria Streptomyces spp. has demonstrated a protective effect and an increase in survival rate for various crustacean (such as the brine shrimp, the giant tiger prawn, the Asian tiger shrimp, the black tiger shrimp, and the white leg shrimp) when challenged with pathogenic Vibrio bacterial strains.

Hence, aquatic species may be threatened by pathogenic microbes. When considering shrimp in particular, Luminescent Vibrio bacteria (such as e.g. Vibrio harveyi or V. splendidus) may for example be pathogenic to shrimp and cause large-scale mortality during production (in the aquaculture reservoir). Therefore, according to the present invention, it may be beneficial to promote the proliferation of probiotic first microbes relative to said pathogenic second microbes, because such supplemented probiotic first microbes may affect and antagonize pathogenic second microbes. Namely, for example, a more species-diverse microbiota in the shrimp's gut facilitates resistance to a greater degree of potentially problematic (pathogenic) colonizers, as there is consequently a larger set of species-species antagonisms.

In embodiments, the second microbes may be selected from the group comprising the genera Vibrio, for example. In embodiments, the second microbes may be one or more of the groups of: Luminescent Vibrio, Vibrio harveyi, V. splendidus, V. parahaemolyticus, V. anguillarum, White Spot Syndrome Virus (WSSV), Yellow Head Virus (YHV), Enterocytozoon hepatopenaei (EHP), Aeromonas, Leucothrix sp., Vorticella, Epistylis, Zoothamnium, Acineta, Ephelota, Staphylococcus Aureus, P. damselae, E. tarda, A. salmonicida, Streptococcus parauberis, S. iniae.

Such second microbes may be pathogenic and detrimental for aquatic species, such as for example crustaceans. To illustrate: The virus White Spot Syndrome Virus (WSSV) is one of the significant threats to worldwide shrimp farming. The parasitic fungus (or: microsporidian) Enterocytozoon hepatopenaei (EHP) is the main cause of Hepatopancreatic microsporidiosis (HPM) disease. As a further example, the microbe Vibrio parahaemolyticus may cause Early Mortality Syndrome (EMS) in penaeid shrimp, which may kill a whole population of penaeid shrimp upon outbreak therewith. For example, the microbe Leucothrix sp. may cause Filamentous Bacterial Disease (FBD) that affects shrimp.

As mentioned, the selected lighting characteristic is configured to promote the persistence of the first microbes relative to the second microbes in the aquaculture reservoir.

The term ‘persistence’ may herein especially refer to the continued presence of the first microbes, especially relative to the second microbes. Hence, light source light may comprise a lighting characteristic, said lighting characteristic being a spectral power distribution selected for promoting the presence of the first microbes, especially relative to the second microbes. The response of microbes to particular spectra of light, and/or their sensitivity to a light spectrum, may be determined by their respective action spectra.

In particular, in embodiments, the light source light may have a (lighting characteristic having a) spectral power distribution selected for positively affecting the first microbes, such as promoting growth of the first microbes, especially relative to the second microbes. Thereby, the first microbes may accumulate in the aquaculture reservoir and the marine environment thereof. In further embodiments, the light source light may have a (lighting characteristic having a) spectral power distribution selected for negatively affecting the second microbes, such as deactivating the second microbes, especially diminishing growth of the second microbes. Thereby, the second microbes may diminish in the microbiome of the aquaculture reservoir, which may consequently diminish, especially remove, or reduce, a competitor for the first microbes.

In particular, the light source light may comprise a lighting characteristic, wherein the lighting characteristic may comprise a spectral power distribution selected to provide a competitive advantage to the first microbes relative to the second microbes, i.e., to promote the persistence of the first microbes relative to the second microbes in the aquaculture reservoir. A competitive advantage may be provided by providing a larger benefit (or smaller detriment) to the first microbes relative to the second microbes. Thereby, the first microbes may persist in the marine environment of the aquaculture reservoir, especially (over time) become more prevalent in the aquaculture reservoir, with respect to the second microbes.

Hence, in an embodiment, the (selected) lighting characteristic according to the invention comprises a spectral power distribution; wherein the spectral power distribution is selected for one or more of: (i) promoting growth of the first microbes, (ii) deactivating (or: diminishing growth of the) second microbes, (iii) deactivating second microbes more strongly than the first microbes. In aspects, said (selected) lighting characteristic may also comprise a spectral power distribution for deactivating viruses.

In an embodiment, the lighting characteristic may comprise a spectral power distribution; wherein the spectral power distribution comprises at least one peak wavelength in the range of 100-380 nanometers, and/or at least one peak wavelength in the range of 380-435 nanometers. Hence, light source light may be ultraviolet (UV) light or Violet light. Hence, the corresponding lighting characteristic is the type of UV light, or Violet light. Said ultraviolet light may for example be UV-C light, Far-UV-C light, Near-UV-C light, UV-B light, and/or UV-A light. Hence, the light source light may be germicidal light, or antibacterial light, or antiviral light.

In an embodiment, the lighting characteristic may further comprise an intensity. Said intensity may be phrased as a light intensity. Light-based deactivation of microbes may namely not only depend on the wavelength of light source light emitted into the aquaculture reservoir, but may also depend on the light intensity of said light source light that is emitted into the aquaculture reservoir.

In an embodiment, the lighting characteristic may further comprise a lighting duration. In an embodiment, as partly mentioned, the lighting characteristic may further comprise a lighting spectrum. Said spectrum may for example comprise one or more types of UV light. A combination of a lighting spectrum, light intensity, and lighting duration may define a light recipe. Hence, the lighting characteristic according to the invention may be a light recipe.

More specifically, in an embodiment, said lighting characteristic may comprises a spectral power distribution comprising at least one peak wavelength substantially at 254 nm, 222 nm, 275 nm, 405 nm. Such wavelengths may promote the first microbes over the undesired second microbes. In aspects, as partly mentioned, said second microbes may for example be viruses.

More specifically: For example, in an embodiment, the first microbes may be one or more from the group of Bacillus, wherein the second microbes may be one or more of the groups of Luminescent Vibrio. The action spectra of Bacillus in water may indicate a higher absorbance of ultraviolet (UV) light below 240 nm, and lower absorbance of UV light above 240 nm. The action spectra of Luminescent Vibrio may indicate a higher absorbance of ultraviolet (UV) light in the range between 240 nm and 280 nm, or below 220 nm. Hence, considering these action spectra, Bacillus may be promoted over Luminescent Vibrio when the aquaculture reservoir is illuminated with germicidal UV light in the range between 240-280 nm, preferably substantially around 265 nm, because this wavelength deactivates the pathogenic Vibrio bacteria while being close to the minimum spectral sensitivity or absorbance of the probiotic Bacillus.

Similar examples may be envisioned for other first microbes and second microbes. For example, the pathogenic second microbes Photobacterium damselae, Vibrio anguillarum, and Edwardsiella tarda appear in experiments to be most susceptible to 405 nm light. The same susceptibility to 405 nm light applies to the second microbe Aeromonas salmonicida, which bacterium is pathogenic to fish, particularly salmon.

Moreover, in the aquaculture sector, the microbe Exophiala sp. fungus may also be recognized as pathogenic to aquatic species. Exophiala sp. is particularly resistant to UV-C light in the range of 200-280 nm, and to some extent to UV-B light in the range of 280-320 nm, but less to ‘environmental UV’ light comprising more than 85% UV-A light 320-420. Exophiala sp. is not resistant to 405 nm ultraviolet light.

Hence, in case the first microbe is the probiotic Bacillus, which has a higher absorbance of ultraviolet light below 240 nm, the lighting controller according to the present invention may purposefully select the lighting characteristic to be a spectral power distribution comprising a peak wavelength substantially around 405 nm; thereby causing light-based deactivation of the pathogenic second microbe to higher degree compared the probiotic Bacillus, thus causing the proliferation of Bacillus over said pathogens in the aquaculture reservoir. Said selection may for example be based on the action spectra of the respective first microbes and second microbes.

All in all, according to the present invention, the lighting controller selects the lighting characteristic such that the light source light illuminates the aquaculture reservoir with an optimal wavelength of light, based on the pathogenic second microbes present in the aquaculture reservoir and the beneficial (e.g. probiotic) first microbes present in the aquaculture reservoir.

Since there is a great variation in action spectra in deactivating different microbes, such as the mentions pathogens and probiotics, the lighting controller may be configured to access such action spectra, and determine or select said lighting characteristic based thereon; for example an optimum wavelength for deactivating the second microbe more than the first microbe in the aquaculture reservoir.

It is further an object of the invention to provide an improved method of illuminating an aquaculture reservoir, which at least alleviates the problems and disadvantages mentioned above. Thereto, the invention provides a method of illuminating an aquaculture reservoir, wherein the aquaculture reservoir comprises an aquatic species, first microbes, and second microbes other than the first microbes, wherein the method comprises: obtaining a first microbiome signal indicative of the first microbes being present in the aquaculture reservoir; obtaining a second microbiome signal indicative of the second microbes being present in the aquaculture reservoir; selecting a lighting characteristic based on the control signal, wherein the selected lighting characteristic is configured to promote the persistence of the first microbes relative to the second microbes in the aquaculture reservoir; controlling a light source to illuminate the aquaculture reservoir with light source light comprising said selected lighting characteristic. Thereby, advantages and/or embodiments applying to the lighting system according to the invention may mutatis mutandis apply to said method according to the invention.

In an embodiment, the method according to the invention may further comprise: a microbiome dispenser device providing the first microbes to the aquaculture reservoir and, upon providing the first microbes to the aquaculture reservoir, conveying the first microbiome signal.

In further aspects according to the invention, not claimed, the lighting system may comprise a detector device for detecting at least one location of the aquatic species in the aquaculture reservoir and generating a location signal. The location signal is indicative of said at least one location of the aquatic species in the aquaculture reservoir. The detector device may convey said location signal (directly, or indirectly via intermediate devices) to the lighting controller according to the invention. The lighting controller according to the invention may be configured to receive or retrieve said location signal. The lighting controller may be configured to control the light source to illuminate the aquaculture reservoir with light source light comprising said selected lighting characteristic based on said location signal, wherein the light source is configured to illuminate said at least one location in the aquaculture reservoir. The light source may thereby be a plurality a light sources, such as a plurality of luminaires illuminating (different regions within) the aquaculture reservoir, such as an array of luminaires. Such an embodiment may render lighting efficiency, as the locations where the aquatic species are present is optimally illuminated accordingly with the lighting characteristic.

In an aspect, not claimed, the lighting controller may be configured to receive or retrieve a water replenishment signal, wherein the water replenishment signal is indicative of water being removed, replenished and/or replaced from the aquatic reservoir, wherein the lighting controller is configured, upon receiving or retrieving said water replenishment signal, to obtain a new first microbiome signal indicative of new first microbes being present in the aquaculture reservoir and a new second microbiome signal indicative of new second microbes being present in the aquaculture reservoir; wherein the lighting controller is configured to select a new lighting characteristic based on the new first microbiome signal and the new second microbiome signal, wherein the selected new lighting characteristic is configured to promote the persistence of the new first microbes relative to the new second microbes in the aquaculture reservoir; wherein the lighting controller is configured to control the light source to illuminate the aquaculture reservoir with light source light comprising said selected new lighting characteristic. Hence, upon water being removed, replenished and/or replaced from the aquatic reservoir, the lighting system re-assesses the microbiome situation in the aquaculture reservoir, and updates the lighting characteristic accordingly.

In aspects, not claimed, it is found that seasonal microbes (e.g. bacteria) may pop up in a marine environments every season, such as e.g. every spring. Hence, time may be a proxy to the presence of second microbes in the aquaculture reservoir. The same may apply to particular environmental conditions at which pathogenic second microbes may occur (or: become actively present).

Hence, in aspects, not claimed, the lighting system may comprise a receiver unit for receiving environmental information; wherein the environmental information is indicative of one or more of: time, geographical location, temperature in the aquaculture reservoir, atmospheric temperature at the location of the aquaculture reservoir, humidity at the location of the aquaculture reservoir, precipitation at the location of the aquaculture reservoir, water turbidity and/or velocity in the aquaculture reservoir; wherein the receiver unit is configured to receive said environmental information and convey the environmental information to the lighting controller, wherein the lighting controller is configured to determine the second microbiome signal based on said environmental information.

Said environmental information may for example be atmospheric information. Said atmospheric information may for example be received from a weather station. Hence, the lighting system may be operatively coupled to a weather station, thereby forming an overarching control system. The environmental information may be a proxy in determining the second microbiome signal indicative of the second microbes being present in the aquaculture reservoir. For example, it is known that certain pathogenic microbes occur seasonally, or in certain (atmospheric or) environmental conditions. The lighting controller determining the second microbiome signal based on said environmental information may for example comprise processing power comprising an Artificial Intelligence engine.

It is recognized that in aquaculture the water of the aquaculture reservoir is often refreshed with fresh water, wherein the already used water of the aquaculture reservoir may be released in the ambient marine environment (for example a sea, lake, river, etc.). It is further recognized that the use of probiotics in aquaculture may also render that, after harvest (or: removal) of the aquatic species in the aquaculture reservoir, the aquaculture reservoir may contain an unnatural high amount of probiotics that are normally not present in the ambient marine environment to which said water is subsequently released. This may cause pollution of the ambient marine environment. Such operation in aquaculture may represent a risk of causing environmental imbalances, particularly because aquaculture farms may be using probiotic mixtures and discharge their effluents directly into the ambient marine environment, such as the ocean, without prior treatment. Hence, it may be beneficial to render a solution with the present lighting system according to the invention, wherein after harvesting of all the aquatic species, a disinfection light may deactivate all probiotics in the aquaculture reservoir before discharging their effluents directly into the ocean.

Hence: In further aspects according to the invention, not claimed, the lighting controller according to the invention may be configured to receive a harvest signal, wherein the harvest signal is indicative of the aquatic species being harvested (i.e. removed) from the aquaculture reservoir, wherein the lighting controller is configured to control the light source to illuminate the aquaculture reservoir with a disinfecting lighting characteristic upon receiving said harvest signal, wherein said disinfecting lighting characteristic is arranged for disinfecting the aquaculture reservoir from microbes being present in the aquaculture reservoir. Said disinfecting lighting characteristic may for example comprise ultraviolet light in the range of 100-420 nm (i.e. all types of UV light, UV-C, UV-B and UV-A). Said disinfecting lighting characteristic may further comprise a light intensity for disinfecting the aquaculture reservoir from microbes. Said disinfecting lighting characteristic may further comprise a lighting duration for disinfecting the aquaculture reservoir from microbes. Hence, said disinfecting lighting characteristic may be a disinfection light recipe. The effect of such disinfecting lighting characteristic being applied to the aquaculture reservoir upon receiving said harvest signal is that a large fraction of microbes being present in the aquaculture reservoir, or for example substantially all microbes, are being disinfected and killed. This may include both the probiotic bacteria as well as the detrimental bacteria being present in the aquaculture reservoir after the aquatic species have been harvested. As a result, (the water of) the aquaculture reservoir may be cleaned.

### BRIEF DESCRIPTION OF THE DRAWINGS

The invention will now be further elucidated by means of the schematic non-limiting drawings:

FIG. 1 depicts schematically an embodiment of a lighting system according to the invention;

FIG. 2 depicts schematically an embodiment of a lighting system according to the invention;

FIG. 3 depicts schematically an embodiment of a lighting system according to the invention;

FIG. 4 depicts schematically action spectra of first microbes and second microbes related to the embodiment of FIG. 1;

FIG. 5 depicts schematically an embodiment of a method according to the invention.

### DETAILED DESCRIPTION OF THE EMBODIMENTS

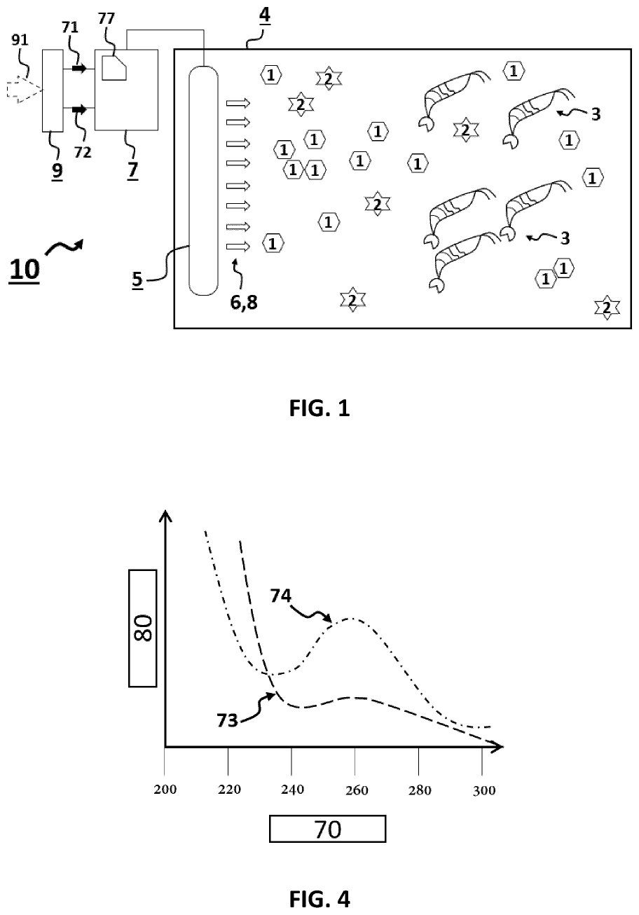

FIG. 1 depicts schematically, by non-limiting example, a lighting system 10 according to the invention. The lighting system 10 is arranged to illuminate an aquaculture reservoir 4. The aquaculture reservoir 4 comprises a volume of water arranged for rearing aquatic species 3. The aquaculture reservoir comprises first microbes 1, second microbes 2, and an aquatic species 3. The second microbes 2 are other than, or different from, the first microbes 1. Here, the aquatic species 3 is shrimp. Here, the aquaculture reservoir 4 is a shrimp tank. Alternatively, the aquatic species may be any other aquatic species mentioned in the present application, such as other crustacean or fish.

The lighting system 10 comprises a light source 5. The light source 5 illuminates, in operation, the aquaculture reservoir 4 with light source light 6. Here, the light source 5 is a luminaire submerged in the volume of water of the aquaculture reservoir 4. Alternatively, the light source may be arranged above a water level of the aquaculture reservoir. Alternatively, the light source may be a plurality of light sources, such as a plurality of LED light sources or laser lighting devices. Alternatively, the light source may be defined as a lighting device.

Referring to FIG. 1, the second microbes 2 are pathogenic to the aquatic species 3, i.e. the shrimp 3. Said second microbes 2 may thus be detrimental microbes to the aquatic species 3. Namely, in the present example, the second microbes 2 are Luminescent Vibrio bacteria.

To cope with said pathogenic second microbes, such as said Vibrio, instead of using disadvantageous antibiotics, microbiota supplementation with probiotics may be performed in aquaculture. Such probiotics may mitigate the onset of disease of aquatic species, and improve the health and survival of the aquatic species, particularly of crustaceans such as shrimp.

Bacillus is well recognized as a probiotic for crustaceans, for example. Hence, the aquaculture reservoir 4 comprises probiotic first microbes 1. Here, the first microbes 1 are Bacillus.

Even though probiotics or probiotic mixtures may provide an advantageous alternative to the use of antibiotics in aquaculture, such as for shrimp farming in particular, the use of probiotic mixtures often copes with a limited proliferation potential in the rearing water for probiotic bacterial species, that are for example not indigenous to the marine environment to which these species are supplied. This may reduce the effectiveness of the supplemented probiotic mixture, and the efficient treatment of the aquatic species therewith, such as the shrimp. Hence, a clear need exists to mitigate disease in aquaculture, reduce the use of antibiotics, and improve the effectiveness and/or efficiency of microbiota supplementation with probiotic mixtures as supplied to the rearing water of aquatic species.

Still referring to FIG. 1, the lighting system 10 according to the invention further comprises a lighting controller 7. The lighting controller 7 communicates with the light source 5 via a wired connection, but alternatively said communication may be via a known wireless communication modality. In such an alternative case, the lighting controller 7 may for example be a portable control device, such as a smartphone or a tablet.

The lighting controller 7 is configured to obtain a first microbiome signal 71. The first microbiome signal 71 is indicative of the first microbes 1 being present in the aquaculture reservoir 4. The lighting controller 7 is further configured to obtain a second microbiome signal 72. The second microbiome signal 72 is indicative of the second microbes 2 being present in the aquaculture reservoir 4. Said first microbiome signal 71 and said second microbiome signal 72 may be a control signal conveyed to the lighting controller 70.

More specifically, the lighting system 10 comprises a user interface device 9. The lighting controller 7 communicates with the user interface device 9 via a wired connection. Alternatively, said lighting controller may communicate with said user interface device via a wireless communication modality. The user interface device 9 comprises a user interface for receiving a user input 91. The user input 91 is indicative of the first microbes 1 and the second microbes 2. The user input device 9 is thereby configured to determine the first microbiome signal 71 and the second microbiome signal 72 based on said user input 91. The user interface device 9 conveys the first microbiome signal 71 and the second microbiome signal 72 to the lighting controller 7. Hence, the lighting controller 7 receives said first microbiome signal 71 and said second microbiome signal 72 from the user interface device 9.

Here, the user interface device 9, or the user interface of the user interface device 9, is a touchscreen display. In the present embodiment, the lighting controller 7 comprises the user interface device 9. The lighting controller may for example be a computing device. Thus, the lighting controller 7 comprises a touchscreen display 9 for receiving said user input 91. The user input 91 may for example be a user selecting a user interface element indicative of the first microbes 1 and the second microbes 2 being present in the aquaculture reservoir 4. Such a user interface element may for example be at least one of: a button, a menu, a drop-down menu, a list, a slider, an image, a switch, a text entry box, a voice entry means, etc.

Still referring to FIG. 1, the lighting controller 7 determines or selects a lighting characteristic 8 based on the first microbiome signal 71 and the second microbiome signal 72. The lighting characteristic 8 is thereby configured to promote the persistence of the first microbes 1 relative to the second microbes 2 in the aquaculture reservoir 4. The term ‘persistence’ may herein especially refer to the continued presence of the first microbes 1, especially relative to the second microbes 2. The lighting controller 7 is further configured to control the light source 5 to illuminate the aquaculture reservoir 4 with light source light 6 comprising said selected lighting characteristic 8.

Here, said lighting characteristic 8 is a spectral power distribution, that is deactivating second microbes 2 (i.e. Luminescent Vibrio) more strongly than the first microbes 1 (i.e. Bacillus). Additionally, or alternatively, a spectral power distribution may be selected for promoting growth of the first microbes 1 (i.e. Bacillus) especially relative to the second microbes 2 (i.e. Luminescent Vibrio). Additionally, or alternatively, said lighting characteristic 8 may be a spectral power distribution selected for negatively affecting the second microbes 2 (i.e. Luminescent Vibrio), such as deactivating the second microbes 2, especially diminishing growth of the second microbes 2. Thereby, the second microbes (i.e. Luminescent Vibrio) may diminish in the microbiome of the aquaculture reservoir 4, which may consequently diminish a competitor for the first microbes 1 (i.e. Bacillus). More specifically, the response of microbes to particular spectra of light, and/or their sensitivity to a light spectrum, may be determined by their respective action spectra.

Still referring to FIG. 1, by non-limiting example, the lighting controller 7 obtains a first action spectra 73 related to the first microbes 1 based on the first microbiome signal 71. The lighting controller 7 also obtains a second action spectra 74 related to the second microbes 2 on the second microbiome signal 72. The lighting controller 7 is configured to select the lighting characteristic 8 based on the first action spectra 73 and the second action spectra 74. The lighting controller 7 may for example be configured to determine and/or select the lighting characteristic 8 by comparing the first action spectrum 73 and the second action spectrum 74.

The lighting controller 7 may optionally comprise a memory device 77. The memory device 77 stores a first action spectra 73 and a second action spectra 74, and/or any further action spectra. The memory device 77 is depicted in FIG. 1 as being part of, or local to, the lighting controller 7. The lighting controller 7 may retrieve said first action spectra 73 and/or said second action spectra 74 from said memory. Alternatively, the memory device may at least partly be remote (or: separate) from the lighting controller. For example, the memory device may be a remote service or cloud.

As a result, the lighting system 10 illuminates the aquaculture reservoir 4 with light source light 6 selected to promote the persistence of the first microbes 1 relative to the second microbes 2 in the aquaculture reservoir 4.

FIG. 4 depicts schematically, by non-limiting example, the first action spectra 73 related to Bacillus and the second action spectra 74 related to Luminescent Vibrio. The first action spectra 73 is thereby defining the sensitivity (or: light absorbance) 80 of the first microbes 1 (i.e. Bacillus) relative to different wavelengths of light 70. The second action spectra 74 is thereby defining the sensitivity (or: light absorbance) 80 of the second microbes 2 (i.e. Luminescent Vibrio) relative to different wavelengths of light 70. A higher sensitivity or light absorbance may indicate a higher rate of light-based deactivation of the respective microbes.

The action spectra 73 of Bacillus in water indicates a higher absorbance of ultraviolet (UV) light below 240 nm, and lower absorbance of UV light above 240 nm. The action spectra 74 of Luminescent Vibrio in water indicates a higher absorbance of ultraviolet (UV) light in the range between 240 nm and 280 nm, or below 220 nm. Hence, considering these action spectra, Bacillus may be promoted over Luminescent Vibrio when the aquaculture reservoir 4 is illuminated with a spectral power distribution (i.e. the lighting characteristic 8) comprising at least one peak in the range between 240-280 nm. Said peak is preferably substantially around 265 nm, because this wavelength deactivates the pathogenic Luminescent Vibrio bacteria while being close to the minimum spectral sensitivity or absorbance of the probiotic Bacillus. Said lighting characteristic 8 may alternatively be phrased as ultraviolet (UV) light comprising a wavelength between 240-280 nm.

All in all, the light source light 6 may be beneficial for the growth and proliferation of the first microbes 1 (Bacillus), and/or may be detrimental to the growth of the second microbes 2 (Luminescent Vibrio). The first microbes 1 are thereby given a competitive advantage over the second microbes 2, thus allowing the first microbes 1 to settle and persist in the aquaculture reservoir 4, and further improving their proliferation in the aquaculture reservoir 4.

Consequently, the aquatic species 3 that are also present in the same aquaculture reservoir 4 can more effectively come in contact with the first microbes 1, and thereby be supplemented with the first microbes 1.

Thus, the present invention promotes the beneficial effects of microbiota supplementation in aquaculture, by purposively selecting a lighting characteristic based on the first microbes and second microbes that are being present in the aquaculture reservoir, which lighting characteristic promotes the persistence of the first microbes relative to the second microbes in the aquaculture reservoir.

Even though the invention is described in FIG. 1 for the aquatic species being shrimp, the first microbes being Bacillus, and the second microbes being Luminescent Vibrio, the present invention may mutatis mutandis be applied to other combinations of aquatic species, beneficial first microbes, and detrimental second microbes.

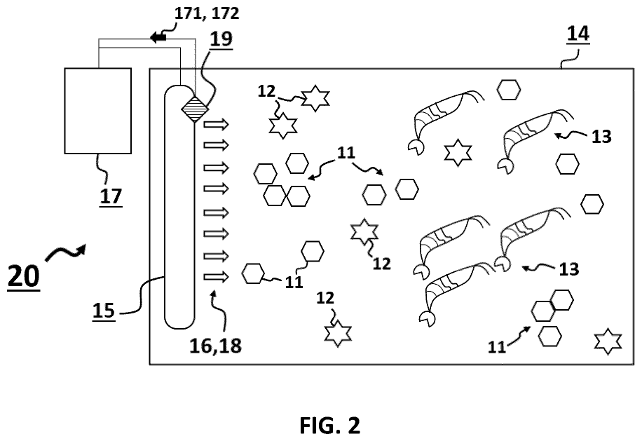

FIG. 2 depicts schematically, by non-limiting example, a lighting system 20 according to the invention, which is at least partly similar to the embodiment depicted in FIG. 1. The lighting system 20 is arranged to illuminate an aquaculture reservoir 14.

The aquaculture reservoir 14 comprises a volume of water arranged for rearing aquatic species 13. The aquaculture reservoir comprises first microbes 11, second microbes 12, and an aquatic species 13. The second microbes 12 are other than, or different from, the first microbes 11. Here, the aquatic species 13 is a crustacean. Here, the aquaculture reservoir 14 is a pond for crustacean. Alternatively, the aquatic species may be any other aquatic species mentioned in the present application.

The lighting system 20 comprises a light source 15. The light source 15 illuminates, in operation, the aquaculture reservoir 14 with light source light 16. Here, the light source 15 is a lighting device that is at least partly submerged in the volume of water of the aquaculture reservoir 24. Alternatively, the lighting device may illuminate the water surface of the volume of water of the aquaculture reservoir.

Referring to FIG. 2, in the present example, the second microbes 12 are Exophiala sp. fungus. The second microbes 12 are pathogenic to the aquatic species 13, i.e. the crustacean 13. To cope with said pathogenic second microbes 12, the aquaculture reservoir 14 also comprises probiotics. Bacillus is well recognized as a probiotic for crustaceans, for example. Hence, the aquaculture reservoir 14 comprises probiotic first microbes 11. Here, the first microbes 11 are Bacillus.

Still referring to FIG. 2, the lighting system 20 according to the invention further comprises a lighting controller 17. The lighting controller 17 communicates with the light source 15 via a wired connection, but alternatively said communication may be via a known wireless communication modality as mentioned in the application.

The lighting controller 17 is configured to obtain a first microbiome signal 171. The first microbiome signal 171 is indicative of the first microbes 11 being present in the aquaculture reservoir 14. The lighting controller 17 is further configured to obtain a second microbiome signal 172. The second microbiome signal 172 is indicative of the second microbes 12 being present in the aquaculture reservoir 14.

More specifically, the lighting system 20 comprises a sensor device 19. The sensor device 19 is in communication with the lighting controller 17. Said communication is presently via a wired connection but may alternatively be via a wireless connection.

Still referring to FIG. 2, the sensor device 19 is configured to receive a sensor input. Here, the sensor device 19 is also configured to determine the first microbiome signal 171 and/or the second microbiome signal 172 based on said sensor input. The sensor input is thereby indicative of the first microbes 11 and/or the second microbes 12 being present in the aquaculture reservoir 14. The lighting controller 17 is configured to receive said first microbiome signal 171 and/or said second microbiome signal 172 from said sensor device 19. The sensor input may for example be the detection signal indicative of the first microbes and/or the second microbes being present in the aquaculture reservoir.

Alternatively, the lighting controller may determine the first microbiome signal and/or the second microbiome signal based on said sensor input, wherein the sensor device may convey said received sensor input directly to the lighting controller.

Alternatively, the lighting controller may receive only said second microbiome signal from said sensor device. Said first microbiome signal may then be received from another device, such as a user interface device. Said sensor device may for example be a camera equipped with processing means to perform image analysis or image recognition, wherein the sensor input is an image of the aquaculture reservoir, which image may be indicative of second microbes, such as White Spot Syndrome Virus (WSSV) or Yellow Head Virus (YHV). Hence, the analyzed properties of the (or derived from the) image may be used as proxy to determine the second microbiome signal.

Alternatively, said sensor device may be an image sensor, which image sensor detects an appearance of the aquatic species, so as to infer that the first microbes and/or the second microbes are present in the aquaculture reservoir. For example, the image sensor may detect an image, or receive an image input, of the gut tract of shrimp. The gut tract of the shrimp (i.e. e.g. the coloring thereof) may be indicative of the presence of probiotics and/or pathogens. The same may apply to the body of fish, of which the coloring detected by an image sensor may be indicative (as a proxy) of first microbes and/or second microbes being present in the aquaculture reservoir.

Still referring to FIG. 2, here, the light source 15 comprises the sensor device 19. The sensor device 19 may for example be a biosensor. Alternatively, the sensor device may be separate from the light source, for example as a standalone unit. Said sensor device may also be outside the aquaculture reservoir, such as a sensor device for analyzing a water sample of the water volume of aquaculture reservoir. Yet in another alternative, the lighting controller may comprise the sensor device. Yet alternatively, the lighting controller, the light source, and the sensor device may be embodied within same housing of the lighting system.

Still referring to FIG. 2, the lighting controller 17 determines or selects a lighting characteristic 18 based on the first microbiome signal 171 and the second microbiome signal 172. The lighting characteristic 18 is thereby configured to promote the persistence of the first microbes 11 relative to the second microbes 12 in the aquaculture reservoir 14. The term ‘persistence’ may herein especially refer to the continued presence of the first microbes 11, especially relative to the second microbes 12.

The lighting controller 17 is further configured to control the light source 15 to illuminate the aquaculture reservoir 14 with light source light 16 comprising said selected lighting characteristic 18. As a result, the lighting system 20 illuminates the aquaculture reservoir 14 with light source light 16 selected to promote the persistence of the first microbes 11 relative to the second microbes 12 in the aquaculture reservoir 14.

Here, said lighting characteristic 18 is a spectral power distribution, that is deactivating second microbes 12 (i.e. Exophiala sp.) more strongly than the first microbes 11 (i.e. Bacillus).

Considering the action spectra of Exophiala sp., Exophiala sp. is not resistant to 405 nm ultraviolet light. The action spectra of Bacillus in water indicates a higher absorbance of ultraviolet (UV) light below 240 nm, and lower absorbance of UV light above 240 nm. Hence, the lighting controller 17 may determine or select the lighting characteristic 18, wherein the selected/determined lighting characteristic comprises a spectral power distribution, wherein the spectral power distribution comprises a peak wavelength substantially at 405 nanometers.

Similar to the embodiment depicted in FIG. 1, the present embodiment depicted in FIG. 2 may comprise the lighting controller receiving or retrieving action spectra relating to said first microbes and said second microbes, and using said action spectra to determine/select the lighting characteristic.

All in all, the light source light 16 may be beneficial for the growth and proliferation of the first microbes 11 (Bacillus), and/or may be detrimental to the growth of the second microbes 12 (Exophiala sp.). The first microbes 11 are thereby given a competitive advantage over the second microbes 12, thus allowing the first microbes 11 to settle and persist in the aquaculture reservoir 14, and further improving their proliferation in the aquaculture reservoir 14.

Consequently, the aquatic species 13 that are also present in the same aquaculture reservoir 14 can more effectively come in contact with the first microbes 11, and thereby be supplemented with the first microbes 11.

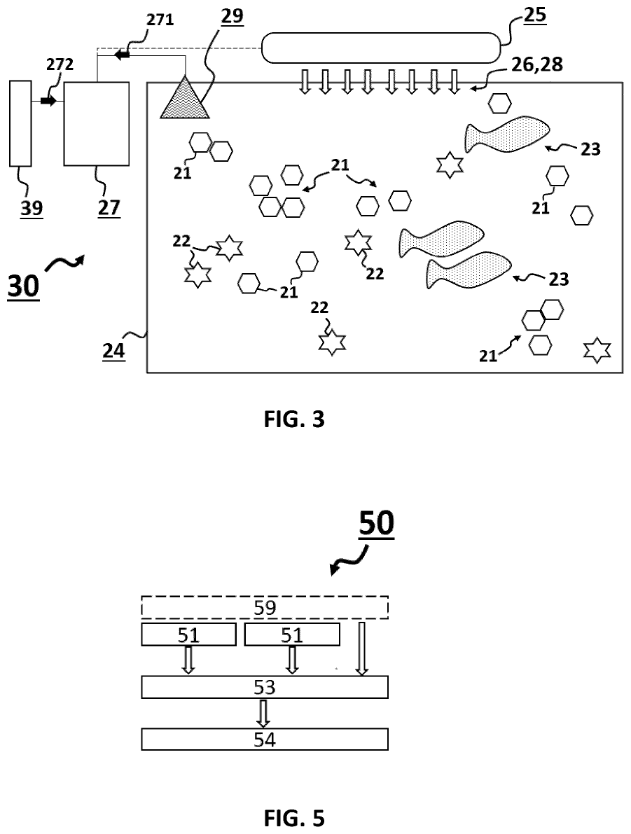

FIG. 3 depicts schematically, by non-limiting example, a lighting system 30 according to the invention, which is at least partly similar to the embodiment depicted in FIG. 1 or FIG. 2. The lighting system 30 is arranged to illuminate an aquaculture reservoir 24. The aquaculture reservoir 24 comprises a volume of water arranged for cultivating aquatic species 23. The aquaculture reservoir 24 comprises first microbes 21, second microbes 22, and an aquatic species 23. The second microbes 22 are other than, or different from, the first microbes 21. Here, the aquatic species 23 is a fish, namely Salmon. Here, the aquaculture reservoir 24 is a fish hatchery. Alternatively, said aquatic species may be Trout, Pike, Perch, Turbot, Halibut.

The lighting system 30 comprises a light source 25. The light source 25 illuminates, in operation, the aquaculture reservoir 24 with light source light 26. Here, the light source 25 is a plurality of luminaires arranged above the aquaculture reservoir 24. More specifically, said luminaires 25 are arranged above the water level of the volume of water of the aquaculture reservoir. Alternatively, the light source may be a plurality of luminaires submerged in the aquaculture reservoir.

Referring to FIG. 3, in the present example, the second microbes 22 are Aeromonas salmonicida. The second microbes 22 are pathogenic to the aquatic species 23, i.e. the salmon 23. The second microbes 22 may cause disease in the salmon 23. To cope with said pathogenic second microbes 22, the aquaculture reservoir 24 also comprises probiotics. Lactobacillus is recognized as a probiotic for salmon, for example. Hence, the aquaculture reservoir 24 comprises probiotic first microbes 21. Here, the first microbes 21 are Lactobacillus.

Still referring to FIG. 3, the lighting system 30 according to the invention further comprises a lighting controller 27. The lighting controller 27 communicates with the light source 25 via a wireless connection, for example ZigBee or Bluetooth, but alternatively said communication may be via a wired communication modality.

The lighting controller 27 is configured to obtain a first microbiome signal 271. The first microbiome signal 271 is indicative of the first microbes 21 being present in the aquaculture reservoir 24. The lighting controller 27 is further configured to obtain a second microbiome signal 272. The second microbiome signal 272 is indicative of the second microbes 22 being present in the aquaculture reservoir 24.

More specifically, the lighting system 30 comprises a microbiome dispenser device 29. The microbiome dispenser device 29 is in communication with the lighting controller 27. Said communication is presently via a wired connection but may alternatively be via a wireless connection. The microbiome dispenser device 29 provides, in operation, the first microbes 21 to the aquaculture reservoir 24. Said providing of first microbes 21 to the aquaculture reservoir 24 is done autonomously; but may in examples also be done by the microbiome dispenser device receiving a control signal for providing said first microbes, or in examples also be done by the microbiome dispenser device automatically following a pre-defined schedule for providing said first microbes.

Still referring to FIG. 3, the microbiome dispenser device 29 is configured to convey, upon providing the first microbes 21 to the aquaculture reservoir 24, the first microbiome signal 271 to the lighting controller 27. Hence, the lighting controller 27 receives said first microbiome signal 271 from the microbiome dispenser device 29. Said first microbiome signal 271 is thereby conveyed via a wireless communication modality, such as said Bluetooth or ZigBee.

Furthermore, the lighting controller 27 comprises a user interface device 39. The user interface device 39 is configured to receive a user input indicative of the second microbes 22 being present in the aquaculture reservoir 34. The user interface device 39 is thereby configured to convey, upon receiving said user input, the second microbiome signal 272 to the lighting controller 27. Hence, the lighting controller 27 receives said second microbiome signal 272 from the user interface device 39. Alternatively, said lighting controller may receive the second microbiome signal from another device, such as a sensor device.

Still referring to FIG. 3, the lighting controller 27 determines or selects a lighting characteristic 28 based on the first microbiome signal 271 and the second microbiome signal 272. The lighting characteristic 28 is thereby configured to promote the persistence of the first microbes 21 relative to the second microbes 22 in the aquaculture reservoir 24. The term ‘persistence’ may herein especially refer to the continued presence of the first microbes 21, especially relative to the second microbes 22.

The lighting characteristic 28 may for example promote the growth of the first microbes 21, may deactivate (or: diminishing growth of the) second microbes 22, or may deactivate second microbes 22 more strongly than the first microbes 21.

The lighting controller 27 is further configured to control the light source 25 to illuminate the aquaculture reservoir 24 with light source light 26 comprising said selected lighting characteristic 28. As a result, the lighting system 30 illuminates the aquaculture reservoir 24 with light source light 26 selected to promote the persistence of the first microbes 21 relative to the second microbes 22 in the aquaculture reservoir 24.

More specifically, here, said lighting characteristic 28 is a spectral power distribution, that is deactivating second microbes 22 (i.e. Aeromonas salmonicida), and/or is deactivating the second microbes 22 more strongly than the first microbes 21 (i.e. Lactobacillus). Said lighting characteristic 28 may, in other examples, additionally comprise a light intensity, and/or a lighting duration.

Considering the action spectra of Aeromonas salmonicida, i.e. said second microbes 22, Aeromonas salmonicida is not resistant to 405 nm ultraviolet light. The action spectra of Lactobacillus in water indicates a higher absorbance of ultraviolet (UV) light below 300 nm, preferably below 260 nm, and lower absorbance of UV light above 300 nm. Hence, the lighting controller 27 may determine or select the lighting characteristic 28, wherein the selected/determined lighting characteristic comprises a spectral power distribution, wherein the spectral power distribution comprises a peak wavelength substantially at 405 nanometers. Alternatively, said selected lighting characteristic may be light with a spectrum within the wavelength range of 300-450 nm, for example.

Similar to the embodiment depicted in FIG. 1, the present embodiment depicted in FIG. 3 may comprise the lighting controller receiving or retrieving action spectra relating to said first microbes and said second microbes, and using said action spectra to determine/select the lighting characteristic.

All in all, the light source light 26 may be beneficial for the growth and proliferation of the first microbes 21 (Lactobacillus), and/or may be detrimental to the growth of the second microbes 22 (Aeromonas salmonicida). The first microbes 21 are thereby given a competitive advantage over the second microbes 22, thus allowing the first microbes 21 to settle and persist in the aquaculture reservoir 24, and further improving their proliferation in the aquaculture reservoir 24.

Consequently, the aquatic species 23 that are also present in the same aquaculture reservoir 24 can more effectively come in contact with the first microbes 21, and thereby be supplemented with the first microbes 21, so as to aid their health.

In alternative embodiments, not depicted, the lighting system may comprise the microbiome dispenser device providing the first microbes to the aquaculture reservoir and subsequently providing the light source light comprising the lighting characteristic, so as to proliferate the first microbes in the aquaculture reservoir, as the selected lighting characteristic is configured to promote the persistence of the first microbes relative to the second microbes in the aquaculture reservoir.

FIG. 5 depicts schematically, by non-limiting example, an embodiment of a method 50 according to the invention. The method relates to a lighting system illuminating an aquaculture reservoir. The aquaculture reservoir comprises thereby an aquatic species, first microbes, and second microbes other than the first microbes. The method 50 comprises a step 51 of obtaining a first microbiome signal indicative of the first microbes being present in the aquaculture reservoir. The method 50 comprises a step 52 of obtaining a second microbiome signal indicative of the second microbes being present in the aquaculture reservoir. The method 50 comprises a step 53 of selecting (or: determining) a lighting characteristic based on the first microbiome signal and the second microbiome signal, wherein the selected lighting characteristic is configured to promote the persistence of the first microbes relative to the second microbes in the aquaculture reservoir. The method 50 comprises further a step 54 of controlling a light source to illuminate the aquaculture reservoir with light source light comprising said selected lighting characteristic.

The method 50 may optionally comprise a step 59 of the lighting controller obtaining a first action spectra related to the first microbes based on the first microbiome signal, and obtaining a second action spectra related to the second microbes on the second microbiome signal, said first action spectra defining the sensitivity (or: light absorbance) of the first microbes relative to different wavelengths of light, and said second action spectra defining the sensitivity (or: light absorbance) of the second microbes relative to different wavelengths of light. The lighting controller may thereby select (or: determine) the lighting characteristic as done in step 53 based on the first action spectra and the second action spectra.

In embodiments, not depicted, the method may optionally comprise a step of a microbiome dispenser device providing the first microbes to the aquaculture reservoir. The method may comprise a further step of, upon providing the first microbes to the aquaculture reservoir, conveying the first microbiome signal to the lighting controller.

In embodiments, not depicted, the method may optionally comprise a step of a user interface device or a sensor device providing the first microbiome signal and/or the second microbiome signal, upon respectively receiving a user input or a sensor input.

1. A lighting system for illuminating an aquaculture reservoir,
wherein the aquaculture reservoir comprises an aquatic species, first microbes, and second microbes other than the first microbes, wherein the lighting system comprises:
a light source for illuminating the aquaculture reservoir with light source light;
a lighting controller configured to:
(i) obtain a first microbiome signal indicative of the first microbes being present in the aquaculture reservoir and a second microbiome signal indicative of the second microbes being present in the aquaculture reservoir;
(ii) select a lighting characteristic based on the first microbiome signal and the second microbiome signal, wherein the selected lighting characteristic is configured to promote the persistence of the first microbes relative to the second microbes in the aquaculture reservoir;
wherein the lighting controller is configured to:
obtain a first action spectrum related to the first microbes based on the first microbiome signal, and obtain a second action spectrum related to the second microbes on the second microbiome signal, and
select the lighting characteristic based on the first action spectrum and the second action spectrum;
(iii) control the light source to illuminate the aquaculture reservoir with light source light comprising said selected lighting characteristic.

2. The lighting system according to claim 1, wherein the lighting system comprises a user interface device;
wherein the user input device is configured to receive an user input and determine the first microbiome signal and/or the second microbiome signal based on said user input;
wherein the user input is indicative of the first microbes and/or the second microbes being present in the aquaculture reservoir;
wherein the lighting controller is configured to receive said first microbiome signal and/or said second microbiome signal from said user interface device.

3. The lighting system according to claim 1, wherein the lighting system comprises a sensor device;
wherein the sensor device is configured to receive a sensor input and determine the first microbiome signal and/or the second microbiome signal based on said sensor input;
wherein the sensor input is indicative of the first microbes and/or the second microbes being present in the aquaculture reservoir;
wherein the lighting controller is configured to receive said first microbiome signal and/or said second microbiome signal from said sensor device.

4. The lighting system according to claim 1, wherein the lighting system comprises a microbiome dispenser device;
wherein the microbiome dispenser device is configured to provide, in operation, the first microbes to the aquaculture reservoir.

5. The lighting system according to claim 4, wherein the microbiome dispenser device is configured to convey, upon providing the first microbes to the aquaculture reservoir, said first control signal to the lighting controller.

6. The lighting system according to claim 1, wherein the aquatic species are crustaceans.

7. The lighting system according to claim 6, wherein the crustaceans are shrimp.

8. (canceled).

9. The lighting system according to claim 1, wherein the aquaculture reservoir comprises a water volume, wherein the light source is submerged in said water volume.

10. The lighting system according to claim 1, wherein the first microbes are one or more of the groups of: Bacillus, B. acidophilus, B. subtilis, B. cereus, B. pumilus, B. licheniformis, B. thuringiensis, B. weihenstephanensis, Lactobacillus, Aerobacter, Nitrobacter spp., Saccharomyces cerevisiae, Acinetobacter, Cellulomonas, Streptococci, Streptococcus agalactiae, Acinetobacter baumannii, Methylomonas methanica, Pseudomonas Stutzeri, Pseudoxanthomonas suwonensis, Geobacillus thermoleovorans, Macrococcus caseolyticus, Sphingobacterium ingobacterium sp., Weeksella virosa, Pedobacter saltans, Oceanithermus profundus, Mycoplasma synoviae, Colwellia, psychrerythraea, Ketogulonicigenium vulgare, Salmonella enterica, Xanthomonas albilineans, Nocardioides sp., Borrelia relia sp. Roseobacter.

11. The lighting system according to claim 1, wherein the second microbes are one or more of: Luminescent Vibrio, Vibrio harveyi, V. splendidus, V. parahaemolyticus, V. anguillarum, White Spot Syndrome Virus (WSSV), Yellow Head Virus (YHV), Enterocytozoon hepatopenaei (EHP), Aeromonas, Leucothrix sp., Vorticella, Epistylis, Zoothamnium, Acineta, Ephelota, Staphylococcus Aureus, P. damselae, E. tarda, A. salmonicida, Streptococcus parauberis, S. iniae.

12. The lighting system according to claim 1, wherein the lighting characteristic comprises a spectral power distribution;
wherein the spectral power distribution is selected for one or more of: (i) promoting growth of the first microbes, (ii) deactivating second microbes, (iii) deactivating second microbes more strongly than the first microbes.

13. The lighting system according to claim 1, wherein the lighting characteristic comprises a spectral power distribution;
wherein the spectral power distribution comprises at least one peak wavelength in the range of 100-380 nanometers, and/or at least one peak wavelength in the range of 380-435 nanometers.

14. A method of illuminating an aquaculture reservoir,
wherein the aquaculture reservoir comprises an aquatic species, first microbes, and second microbes other than the first microbes, wherein the method comprises:
obtaining a first microbiome signal indicative of the first microbes being present in the aquaculture reservoir;
obtaining a second microbiome signal indicative of the second microbes being present in the aquaculture reservoir;
selecting a lighting characteristic based on the control signal, wherein the selected lighting characteristic is configured to promote the persistence of the first microbes relative to the second microbes in the aquaculture reservoir;
controlling a light source to illuminate the aquaculture reservoir with light source light comprising said selected lighting characteristic;
obtaining a first action spectrum related to the first microbes based on the first microbiome signal, and obtaining a second action spectrum related to the second microbes on the second microbiome signal; and
selecting the lighting characteristic based on the first action spectrum and the second action spectrum.

15. (canceled)
